(19) United States
(12) Patent Application Publication
(10) Pub. No.: US 2023/0298120 A1
(43) Pub. Date: Sep. 21, 2023

(54) SYSTEM, METHOD, APPARATUS, AND COMPUTER PROGRAM PRODUCT FOR JURISDICTIONALLY COMPLIANT STAFFING MANAGEMENT WITHIN CORRECTIONS FACILITIES

(71) Applicant: William David Colon, Warwick, NY (US)

(72) Inventor: William David Colon, Warwick, NY (US)

(21) Appl. No.: 17/655,079

(22) Filed: Mar. 16, 2022

(51) Int. Cl. G06Q 50/26; G06Q 10/10; G06Q 30/00

(52) U.S. Cl. CPC G06Q 50/26; G06Q 10/1093; G06Q 30/018

(57) ABSTRACT

A system, method, apparatus, and computer program product that provides a strategically integrated interdisciplinary staffing and budgetary management system for staffing of corrections facilities. The Constitutional Public Safety Staff Management System (CPSSMS) incorporates effective methodologies for regulating the staffing management of public and private sector organizations as it pertains to the administrative governance of domestic public safety organizations within the American criminal justice system. The CPSSMS include a Schedule Mapping Tool; a Tour, Group, Squad Balance Calibration Tool; an Enhanced Overtime Code Mapping Tool; an Overtime Tracking System; a Governed System Compliance Engine; and a Sequential Staff Sort System. The CPSSMS provides for operational staffing of the corrections facility and can be utilized for documenting requirement shortfalls for obtaining legislative and other budgetary requirements to maintain humane conditions and constitutional standards of confinement that promote the general welfare of individuals held within an institutional jail or prison setting.

### BACKGROUND OF THE INVENTION

The present invention relates to corrections facilities, and more particularly to determining jurisdictionally compliant staffing management within corrections facilities.

An optimal criminal justice system requires the establishment of measures that can be applied to every State that are bound by the Constitution for the United States of America. Throughout the United States today many government law enforcement agencies and privately operated organizations are going through very challenging times in the management of jails and prisons within the criminal justice system. Corrections facilities are subject to state and federal Constitutional, statutory, rules and codes, specifying standards for the operation of corrections facilities. For those facilities that have had a history of non-compliance, additional standards may also be included those imposed in the form of consent decrees or adverse judgments.

While the physical facilities are subject to certain standards, a significant component of correctional facility deficiencies can be attributed to inadequate staffing levels in operating the correctional facility. Current staffing management tools are not comprehensive enough to ensure compliance with jurisdictional guidelines governing the operation of the corrections facility. Likewise, compliance with collective bargaining agreements and other contractual agreements may often become subject to constraints by the inability to staff the corrections facility in a comprehensive manner.

As can be seen, there is a need for improved systems, methods, apparatus, and computer program products to provide jurisdictionally compliant staffing management within corrections facilities.

### SUMMARY OF THE INVENTION

In one aspect of the present invention, a system for corrections facility staffing management within a corrections facility is disclosed. The system includes a Schedule Mapping Tool that is configured to create an architecturally structured authorized staff work schedule based on a data extraction of an authorized staffing level specified in an operative table of organization for the corrections facility. A Governed System Compliance Engine is configured to validate the architecturally structured authorized staff work schedule based on a plurality of jurisdictional standards specified for a minimum operational staffing of the corrections facility, to create a validated architecturally structured authorized staff work schedule defining one or more authorized position requirements for maintaining for a minimum staffing for a compliant operation of the corrections facility.

In some embodiments, a Tour, Group, Squad Balance Calibration Tool is configured to provide a mapping of an authorized, an actual, and an unavailable staff against the one or more authorized position requirements specified in the validated architecturally structured authorized work schedule. The authorized position requirements are designated by a positional rank for each of a shift, a tour group, and a rotation.

In some embodiments, an Overtime Tracking System is configured to determine an operational gap in hours between an available staff and the one or more authorized position requirements. The operational gap is determined for each shift, tour, group, and rotation, during a specified temporal period. The Overtime Tracking System is configured to longitudinally map the operational gap in one or more predictive forecasts.

In some embodiments, an Enhanced Overtime Code Mapping Tool is configured to determine a full-time equivalent headcount required to fulfill the operational gap. The full-time equivalent headcount is determined by a positional rank, and a salary hour of coverage provided by said full-time equivalent headcount. The Enhanced Overtime Code Mapping Tool may also be configured to determine a full coverage factor requirement as in-budget according to one or more overtime code categories and one or more sub-groups within said one or more overtime code categories. The Enhanced Overtime Code Mapping Tool may also be configured to determine a full coverage factor requirement as out-of-budget according to one or more emergency events outside of a budgeted headcount.

In some embodiments, a Sequential Staff Sort System is configured to assign a roster of assigned personnel to each of the one or more authorized position requirements of the validated architecturally structured authorized staff work schedule. The roster of assigned personnel maintains operational continuity in one or more of a staff, a platoon, or a group. The roster of assigned personnel may also account for scheduling of a contractual fringe benefit.

These and other features, aspects and advantages of the present invention will become better understood with reference to the following drawings, description and claims.

### BRIEF DESCRIPTION OF THE DRAWINGS

FIG. 1 is a representative system flow and architecture for the Constitutional Public Safety Staff Management System.

FIG. 2A is a representative Table of Organization.

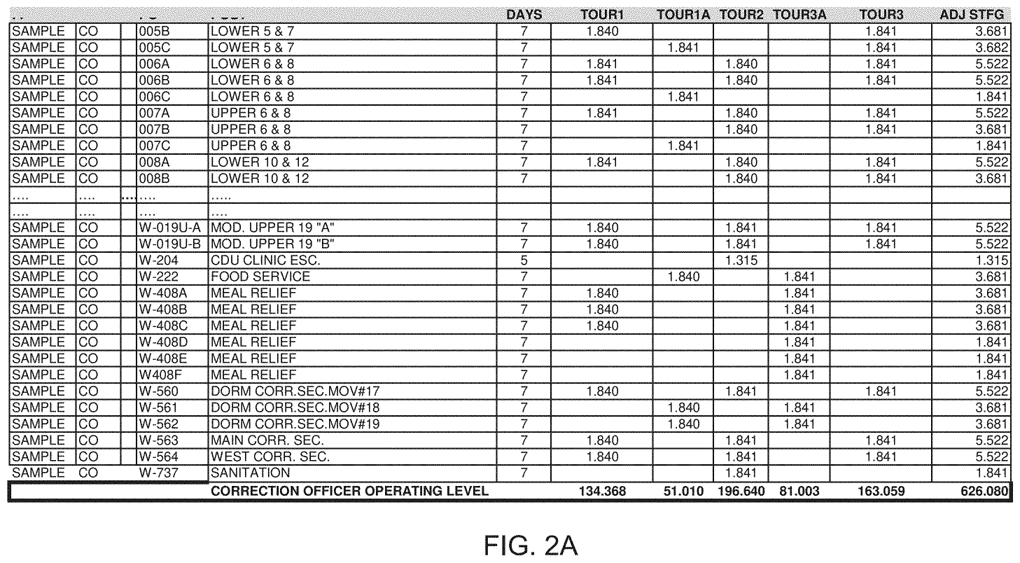

FIG. 2B is data extracted from the Table of Organization for a Tour, Group, Squad Balance Calibration Tool.

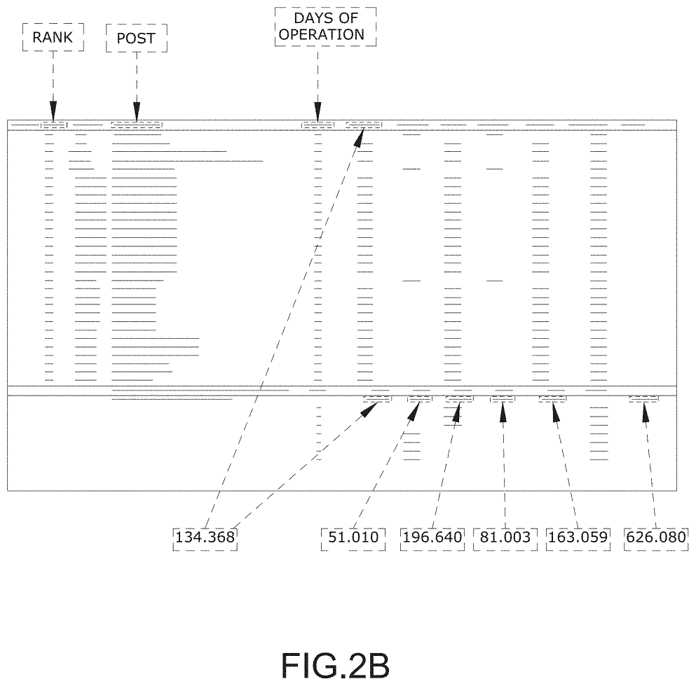

FIG. 3 is a representative implementation of an Operative Organizational Daily Overtime Tracking Report.

FIG. 4 is a representative implementation of Tour, Group, Squad Balance Calibration Tool.

FIG. 5 is a continuation of the Tour, Group, Squad Balance Calibration Tool.

FIG. 6 is a representative implementation of s Sequential Staff Slot System.

FIG. 7 is a representative compliance visualization tool of a Governed System Compliance Engine.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

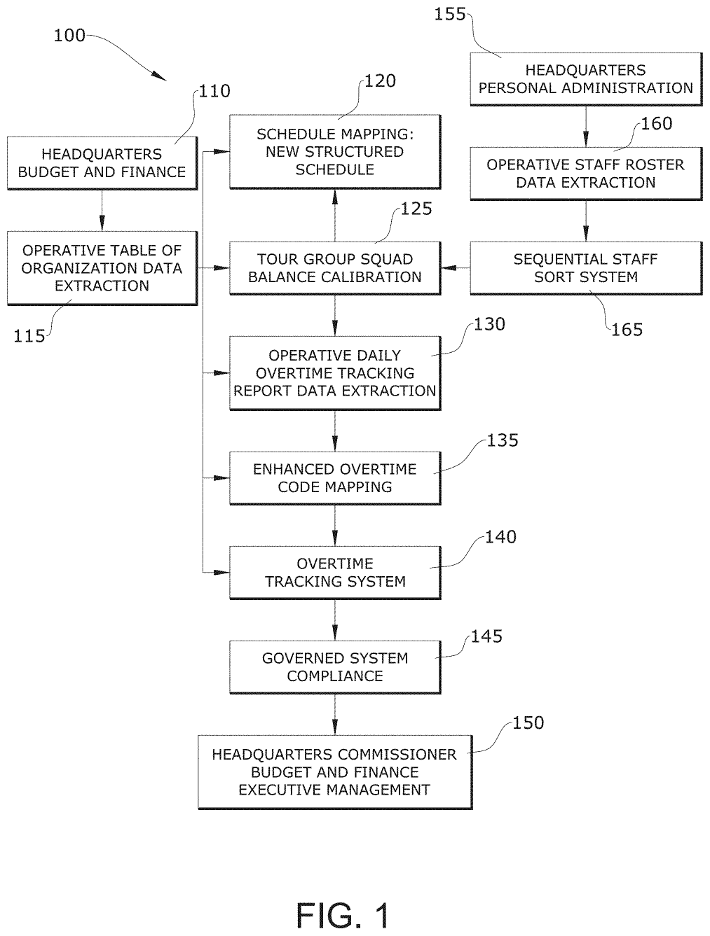

Broadly, embodiments of the present invention provide a system, method, apparatus, and computer program product that provides a strategically integrated interdisciplinary staffing and budgetary management system for staffing corrections facilities. The Constitutional Public Safety Staff Management System (CPSSMS) according to the present invention incorporates effective methodologies for regulating the staffing management of public and private sector organizations as it pertains to the administrative governance of domestic public safety organizations within the American criminal justice system. As seen in reference to FIG. 1, the CPSSMS 100 may include the following components: a Schedule Mapping Tool 120; a Tour, Group, Squad Balance Calibration Tool 125; an Operative Daily Overtime Tracking Reporting Tool 130, an Enhanced Overtime Code Mapping Tool 135; an Overtime Tracking System 140; a Governed System Compliance Engine 145; and a Sequential Staff Sort System 165.

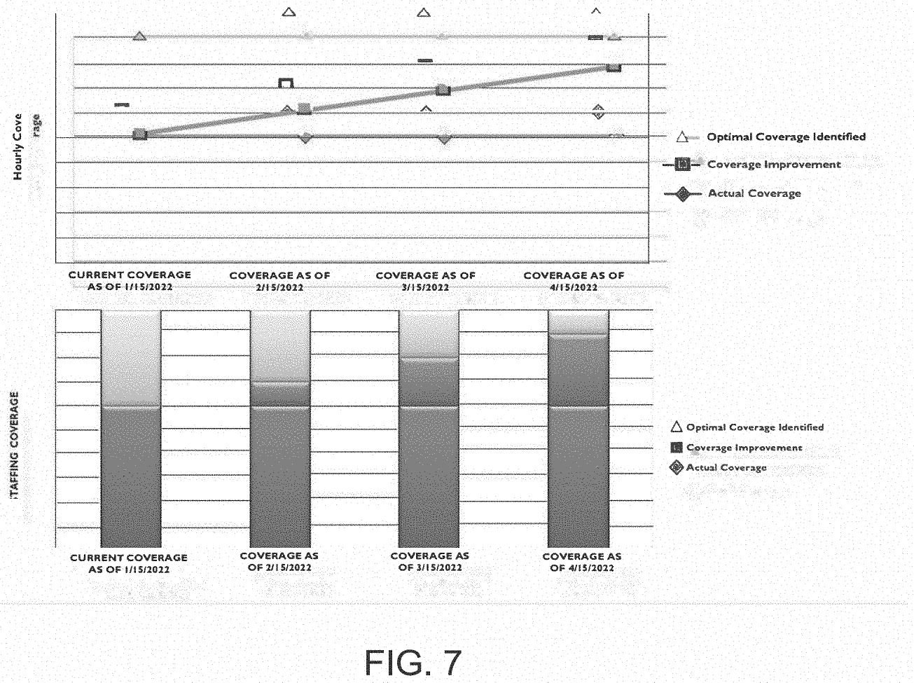

A Governed System Compliance Engine 145 of the CPSSMS monitors compliance with jurisdictional statutory authority, rules and regulations, and codes for determining compliance with requirements of manning formulations and contractual compliance of personnel services for government administrative agencies and privately operated organizations subject to said statutory authority, rules and regulations and codes within governmental jurisdictions. The governed system compliance engine 145 provides visualization tools, such as seen in FIG. 7 for presentation of historical and/or prospective tracking with compliance standards, expressed as an optimal coverage level, against an actual coverage, and a coverage improvement along a selected temporal period.

The CPSSMS provides budgetary data tools, programing, and a governing database that addresses long term goals, current fiscal challenges, and operational constraints with solid operational principles, functionalities, detailed visualizations, tools, and applications to move towards optimizing organizational sustainability in a fiscally prudent and effective manner. The CPSSMS also provides predictive analytics to assess long term fiscal outlooks of operations for future budgetary planning with advanced forecast capabilities.

The CPSSMS provides tools to assure budgetary fitness with robust operational efficiencies for managing organizational performance as they are evolved to meet the societal needs of today. A mapping system provides effective methodologies for assisting organizations in the codification of government administration as it pertains to the management of domestic public safety organizations within the American criminal justice system with effective organizational management and long term fiscal sustainability.

Aspects of the CPSSMS Deliver a digital dashboard to monitor staff management and compliance with jurisdictional statutory authority, rules and regulations and codes, and ordered consent decree judgments, collectively jurisdictional guidelines. The CPSSMS is a systems tool designed to advise and assist in achieving compliance as a neutral third-party compliance consultancy service. The CPSSMS provides a method for effectively enforcing staffing levels to maintain humane conditions and constitutional standards of confinement that promote the general welfare of individuals held within an institutional jail or prison settings.

The CPSSMS provides qualitative data modules, sound data integration, and a unified data governance in the mapping and deployment of personnel. The CPSSMS empowers command and staff 110, 150, 155 with effective managerial methodologies and artificial intelligence in the segmentation, classification, feature extraction, and post-processing of data. The CPSSMS provides a system for sculpting change with a creative innovative technology solution and lifecycle service orchestration that provide long-term sustainability and compliance.

The various tools of the CPSSMS provide longitudinal data measuring staffing levels; volume of overtime, and trending trajectories of each measure per member of service by positional rank. The CPSSMS tools validate structured overtime governance to ensure effective staffing levels are maintained to perform duties according to job descriptions and operational demands. Forecasts for budgetary gaps, operative overtime requirements, and ramp-up times for the appropriation of funding for salaries and fringe benefits for the onboarding of new personnel are also provided.

Elements of the system provide reports to measure staffing fatigue rates and overtime limitations based on threshold set by said organizations and in accordance with applicable jurisdictional statutory authority, rules and regulations and codes of full coverage factor requirements of manning formulations for government administrative agencies and privately operated organizations subject to said statutory authority, rules and regulations and codes within governmental jurisdictions. Requirements to all of which are system rules and safeguards to employ staffing levels as necessary to provide care, custody, and control of inmates in a safe and effective environment in accordance with the law.

Staffing tools provide the capability to evolve operations and right size staffing levels to fulfill organizational transitions. Whether it is through the introduction of new programs, classifications, new facilities or any other factors, including those unique to a particular existing facility.

The CPSSMS delivers predictive data analytics on staffing patterns and frequencies, providing an in- depth analysis of staffing assumptions and methodologies for productivity savings towards future collective bargaining agreements.

The CPSSMS provides validation of operative tables of organization 115, to ensure they are complete in detail and composition in providing authorized post counts and manning formulations as necessary to provide budgeted personnel services of each facility function during each shift regularly scheduled within 24 hours, in accordance with jurisdictional rules and regulation, codes, statutory guidelines and court ordered consent decrees.

Delivers effective methodologies in the management of budgeted manning formulation personnel services. Flagging operative variations that exceed budgeted unit appropriation within personnel services for the evaluation of cause and effect of said events and to ascertain the need for additional personnel services necessary to meet minimum facility staffing requirements. In accordance with applicable jurisdiction full coverage factor statutory requirement.

Delivers system data fabric that establish data management architecture, providing resilient integration of data sources across platforms and users, making data available where it is required within an organization.

### Schedule Mapping Tool

The Schedule Mapping Tool 120 incorporated the digital integration of data from operative agency tables of organization 115 authorized staffing levels by positional rank, tours, and days of operation. The Schedule Mapping Tool 120 provides qualitative data for the strategic mapping of all personnel operating within authorized positional requirements. The Schedule Mapping Tool 120 creates an architecturally structured authorized staff work schedule 120 based on authorized staffing levels and jurisdictional requirements of each facility, post, days, and tours of operation. The Governed System Compliance Engine 145 said system is interfaced and centralized from one master table to each individual command end user 110, 155 making data available where it is required. In accordance with each organization's specification and protocols i.e. personnel, command staff, requiring approval and validation when posted for use. The Schedule Mapping Tool 120 transforms organizational data management systems, from manual-entry dependency and non-integrated systems, to a digitally integrated system governed by system compliance models within the Governed System Compliance Engine 145 managing all Schedule Mapping System 120 functionality requirements and entire systems lifecycle.

Operative tables of organization 115 are detailed in composition to provide authorized post counts and manning formulations as necessary to provide budgeted personnel services of each facility function during each shift regularly scheduled within 24 hours, in accordance to jurisdictional rules and regulation, codes, statutory guidelines and court ordered consent decrees.

Examples of a budgeted unit appropriations within manning formulation for personnel services are shown in the following Table I:

| | |
|---|---|
| General facility administration | Control room operation |
| and management | |
| General housing area supervision | Special housing area supervision |
| Medical services | Visitation |
| Correspondence | Recreation \| Exercise |
| Facility maintenance | Library \| Law library |
| Commissary | Religious services |
| Prisoner transportation | Any additional required program |
| | orservice |

Example of personnel service manning formulation

TABLE II

| | | Number of days based |
|---|---|---|
| Reason for | | on staff manning |
| Absence | Description | formula |
| Pass Days | Difference between calendar | 104.00 |
| | year (365 days) and contractual | |
| | appearance rate (261 days). | |
| Chart Days | Compensation days earned | 20.00 |
| | based on contractual 8-hour | |
| | days, but actual working longer | |
| | workdays i.e.; 8 hrs 30 minutes | |
| | 8 hrs 15 minutes | |
| Sick Days | Sick leave rate fiscal year | 12.00 |
| | average | |
| Miscellaneous | Includes jury duty, maternity | 2.00 |
| Days | leave, AWOL, funeral | |
| | leave, military leave, and | |
| | death in the family, fiscal | |
| | year average | |
| Vacation Days | vacation usage according to | 16.00 |
| | contractual obligations | |
| Training Days | annual in-service training | 5.00 |
| | Total Personnel Service | 159 |
| | Absences | |
| | Operating Days (A) | 365 |
| | Total Personnel Service | 159 |
| | Absences (B) | |
| | Appearance Rate in Days | 206 |
| | (A − B) | |
| | FTE for One Post for 365 Days | 1.772 |
| | [A/(A − B)] | |

### Tour, Group, Squad Balance Calibration Tool

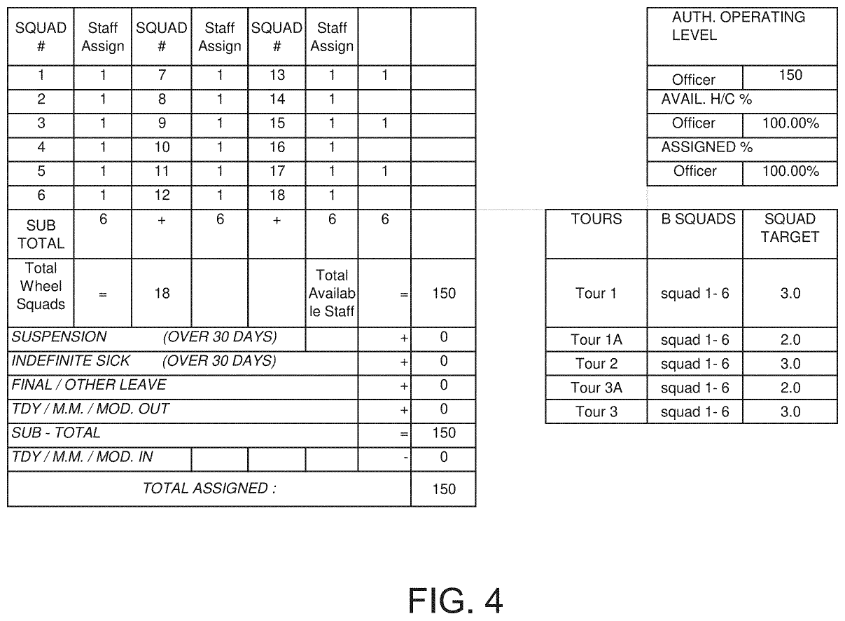

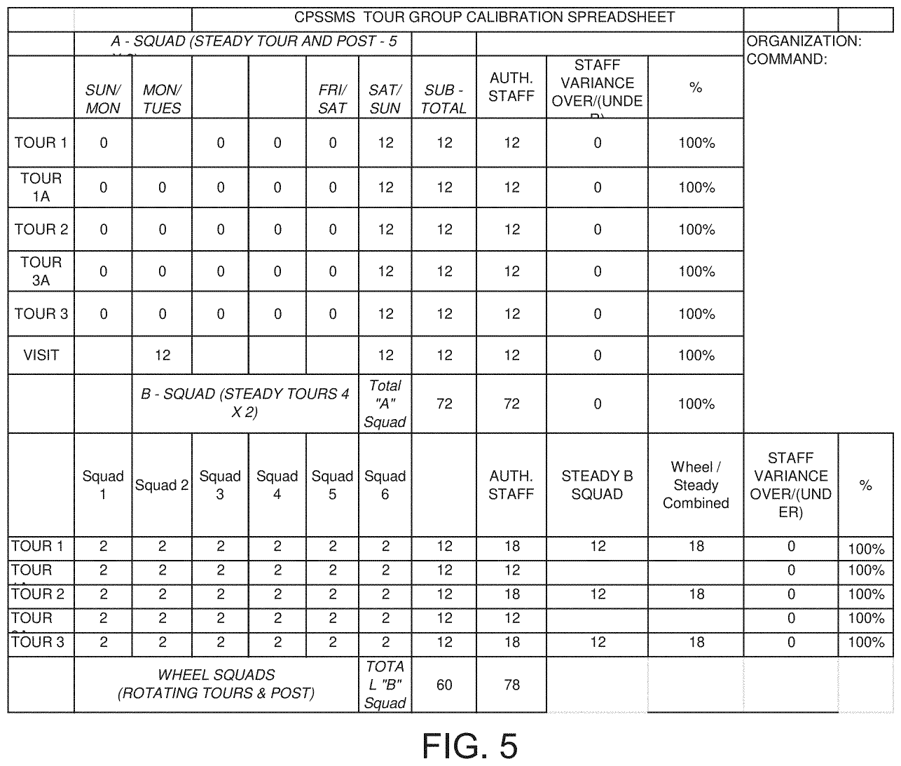

The Tour, Group, Squad Balance Calibration Tool 125 , shown integrates with data from the Schedule Mapping Tool 120. The Tour, Group, Squad Calibration Tool 125 is shown in reference to FIGS. 4 and 5. The Tour, Group, Squad Calibration Tool 125 provides a mapping system of authorized, actual, and available staff against authorized position requirements by positional ranks for each shift, tour group, and rotations, such as “4×2 rotations” or “5×2 rotations”. The authorized position requirements are provided by each organization's authorized operative table of organization 115 specifications by command. Authorized position data is extracted from each organization's table of organization 115, employing multiple measurement indicators providing data management and governance of staffing variances “deficits and surpluses” per each shift, tour group, and rotation for proper staffing calibration and squad reconciliations.

Data quantifications of the Tour, Group, Squad Balance Calibration Tool 125 may be mapped longitudinally to provide methodologically predictive forecasts tracking staffing level trajectories to support organizational decisions; addressing impending staffing shortages, and staff onboarding requirements for future personnel to maintain operational continuity and budgetary fitness. The Tour, Group, Squad Balance Calibration Tool 125 transforms organizational data management systems, from manual-entry dependency and non-integrated systems to fully digital integrated and governed system models, capable of managing all tour group functionality requirements and entire systems lifecycle.

In summary, the Tour, Group, Squad Balance Calibration Tool 125 provides each command with:
Command authorized operating level;
Authorized staffing levels by tour group and rotation;
Available total staff assigned;
Individual squad group totals and sub-totals of all squads by tour and rotation;
Squad percentages by tour group and rotation;
Squad target levels by tour group and rotation;
Squad staff variance over/under per tour group;
Total of unavailable staff i.e.; indefinite sick, final leave/other leave; and
Total of temporary duty assignments, medically monitored, modified duty members assigned in command and members assigned out of command.

### Enhanced Overtime Code Mapping Tool

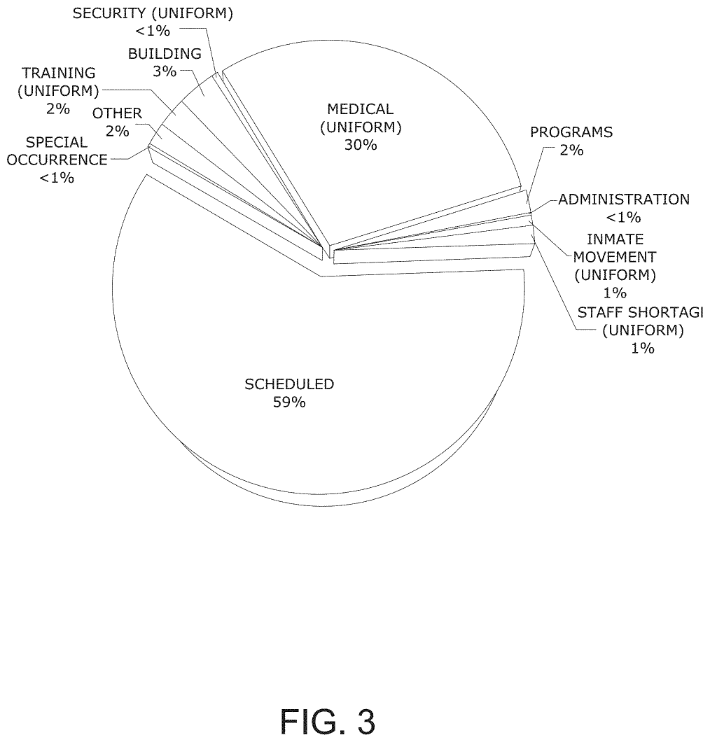

The Enhanced Overtime Code Mapping Tool 135 presents systematic algorithms and actualizations of staff overtime, measuring the exact number of operative personnel to staff a jail or prison system. As seen in reference to FIG. 3, the Enhanced Overtime Code Mapping Tool 135 provides detailed data granularity, forensic digital threading, and forecast capabilities to provide safe and effective staff management in conformance with each organization's jurisdictional guidelines. The Enhanced Overtime Code Mapping Tool 135 includes two components.

Data for the Enhanced Overtime Code Mapping Tool 135 may be Integrated from the Schedule Mapping Tool 120 and from Operative Organizational Daily Overtime Tracking Reports 130, as posted, providing real time qualitative data synthesis, matching each organizations overtime code systems specifications.

During initial data integration, an analysis of operative organizational overtime tracking systems is conducted, ensuring full data traceability and logical data pathways for digital threading in accordance to applicable jurisdictional requirements and guidelines. The Enhanced Overtime Code Mapping Tool 135 transforms organizational data management systems from manual-entry dependency and non-integrated systems to fully digital integrated and governed system models, managing all Enhanced Overtime Code Mapping 135 functionality requirements and systems lifecycle.

The first component for the Enhanced Overtime Code Mapping Tool 135 provides measures of full coverage factor requirements of manning formulations representative of a full-time equivalent of personnel headcount by positional rank, the salary hours of coverage provided by said full-time equivalent headcount, and “in-budget” hours of overtime incurred due to staffing gaps. The full-time equivalent is determined in accordance with applicable jurisdictional statutory authorities, rules and regulations, and codes of a full coverage factor requirement of manning formulations for government administrative agencies and privately operated organizations subject to said applicable statutory authority, rules and regulations, and codes within governmental jurisdictions.

The full coverage factor requirement may be presented in hours, percentage, and monetary levels, for a daily, a monthly, a quarterly and a fiscal year. The full coverage factor requirement may be categorized as “in-budget” providing numerical values of full-time equivalent (per officer by positional rank) and percentage of staff required to absorb said “in-budget” overtime, as categorized by one or more overtime codes and sub-groups within said one or more overtime codes categories.

Code quantifications of the first component categorized as “in-budget” of jurisdictional full coverage factor requirements of manning formulation of daily staffing requirements may be flagged as significant once they exceed 2.5% percent of a total unit appropriation authorized of manning formulations for said budgeted personnel service within each position rank. Said actions create a mechanism for the evaluation of the cause and effect of said events and to ascertain the need for additional personnel services necessary to meet minimum facility staffing requirements in accordance to applicable jurisdiction full coverage factor statutory requirements.

The second component for Enhanced Overtime Code Mapping Tool 135 provides measures of the full coverage factor requirements of manning formulations representative of the full-time equivalent of uniform personnel headcount overtime incurred due to facility added post and emergency events outside of a budgeted headcount. The measures are determined in accordance with jurisdictional statutory authority, rules and regulations and codes of full coverage factor requirements of manning formulations for government administrative agencies and privately operated organizations subject to said statutory authority, rules and regulations and codes within governmental jurisdictions. The measures may be presented in hours, percentage, and/or monetary levels, for daily, monthly, quarterly and fiscal year and categorized as “out-of-budget” providing numerical values of full time equivalent (per officer by positional rank) and percentage of staff required to absorb “out-of-budget” overtime.

Code quantifications of the second component categorized as “out-of-budget”, that is, outside of the budgeted head count are quantified daily and flagged as significant once they exceed 2.5% percent of staffing levels within each position rank. These actions create a mechanism for the evaluation of the cause and effect of said events and to ascertain the need for additional personnel services necessary to meet minimum facility staffing requirements in accordance with the applicable jurisdiction full coverage factor statutory requirement.

As seen in FIG. 3, Enhanced Overtime Code Mapping Tool 135 can provide the following measures:

Code quantifications of overtime due to facility added post activations, may be flagged once they manifest to ensure adherence to jurisdictional guidelines;

Code quantifications due to non-coverage of post by personnel, classified as an unmanned post and flagged once they manifest as a manning deficit to ensure adherence with jurisdictional guidelines;

Code quantifications due to post shift reductions, may be classified as a post closure and flagged once they manifest to ensure adherence with jurisdictional guidelines;

Code quantifications of components one and two may be mapped longitudinally with a stacked bar charts and/or pie charts providing overtime trends, methodologically predictive forecasts, and drill down reports to support organizational decisions and budgetary fitness by measuring the quantification of both in-budget and out-of-budget overtime activity.

### Overtime Tracking System

The Overtime Tracking System 140 tracks the volume of staff overtime and trajectories of overtime per members of service by positional rank and command, mapping minimum staffing requirements for each facility, by tour group and rotation. Overtime Tracking System 140 provides real-time data and predictive forecasts of operative overtime requirements to manage ramp-up scheduling for the appropriation of funding and onboarding of new personnel. The governance of said system shall be centralized from one master table to each facility end user, making data available where it is required, in accordance to each organization's specification and protocols i.e. personnel, command staff.

The Overtime Tracking System 140 integrates data from the Schedule Mapping Tool 120 and the Enhanced Overtime Code Mapping Tool 135. Data may be quantified by overtime hours as scaled by changes in staffing availability. Overtime reports 130 may be generated daily, weekly and monthly.

The methodology measures operational gap in hours between available staff and a minimum facility staffing requirement for each facility to be performed by each shift, tour, group, and rotation, regularly within a 24-hour period.

The Overtime Tracking System 140 may be mapped longitudinally to provide methodologically predictive forecasts that support organizational decisions and budgetary fitness. Overtime Tracking System 140 measures overtime quantifications and staffing fatigue rates, due to both in-budget overtime activity and out-of-budget activity providing staffing safety baselines to map out daily, weekly and monthly overtime targets. Transforming organizational overtime data management systems, from manual-entry dependency and non-integrated systems, to digitally integrated governed system models managing all Overtime Tracking System 140s functionality requirements and entire systems lifecycle.

### Sequential Staff Sort System

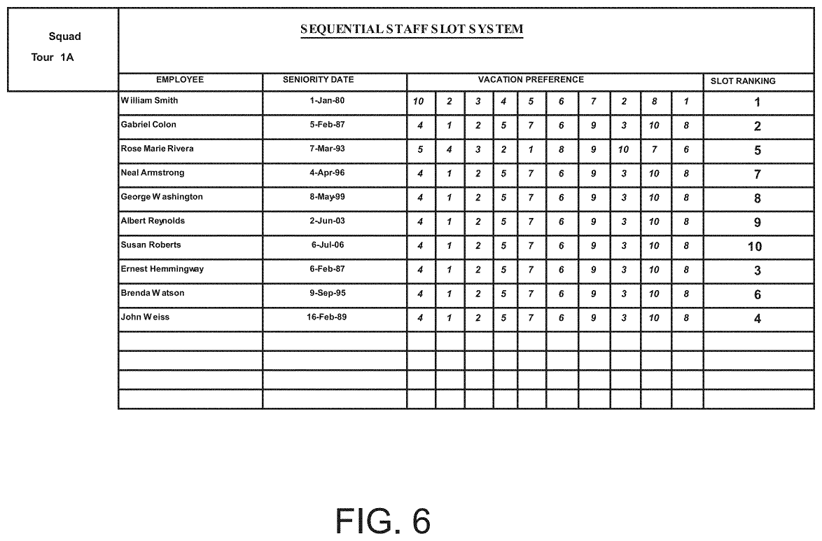

The Sequential Staff Sort System 165, shown in FIG. 6, employs multiple measurement indicators, providing digital integration of data management systems governing the process of staffing positions by seniority, tour, group, and rotation. The Sequential Staff Sort System 165 integrates data from Schedule Mapping Tool 120 and the Tour, Group, Squad, Balance Calibration Tool 125. Utilizing the Sequential Staff Sort System 165, staff rosters 160 are strategically structured to meet each organization's supply and demand of personnel services according to authorized schedule mapping specifications 120, maintaining operational continuity and compliance in the administrative management of staff, platoon, or group rosters 160 by tour, group, and rotation for scheduling of contractual fringe benefits i.e. vacation picks selections, post awards, and employee data in accordance to each organizations' specification 115. The Sequential Staff Sort System 165 ensures appearances by assigned staff are made uniformly across days and tours, eliminating asymmetrical staffing patterns that are inconsistent with operative organizational tables 115 of organizations.

The Sequential Staff Sort System 165 transforms organizational data management systems, from manual-entry dependency and non-integrated systems, to digitally integrated and governed system compliance models 145, managing all functionality requirements and entire systems lifecycle.

The Sequential Staff Slot Sort System 165 may be utilized to sort staff with composite listing reports to include:

Employee name by command;

Employee seniority date and list number by command;

Employee vacation preference in slot ranking order 1st choice to 10th choice.

Vacation slots awarded as categorized, fiscally according to binding contractual agreements by command;

Employee tour group, i.e. tour 1, tour 1A, tour 2, tour 3A, tour 3 and rotation, i.e. “4×2 rotation, 5×2 rotation” by command;

Employees on terminal leave shall have their vacation slots awarded in according to seniority within first slots of available vacation picks by command;

Dates of employee statutory and ancillary training certifications by command; and

Additional employee data in accordance with each organizations' specification.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for corrections facility staffing management within a corrections facility, comprising:
a Schedule Mapping Tool configured to create an architecturally structured authorized staff work schedule based on a data extraction of an authorized staffing level specified in an operative table of organization for the corrections facility; and
a Governed System Compliance Engine configured to validate the architecturally structured authorized staff work schedule based on a plurality of jurisdictional standards specified for an operational staffing of the corrections facility, to create a validated architecturally structured authorized staff work schedule defining one or more authorized position requirements for maintaining for a minimum staffing for a compliant operation of the corrections facility.

2. The system for corrections facility staffing management of claim 1, further comprising:
a Tour, Group, Squad Balance Calibration Tool configured to provide a mapping of an authorized, an actual, and an unavailable staff against the one or more authorized position requirements specified in the validated architecturally structured authorized work schedule.

3. The system for corrections facility staffing management of claim 2, wherein the authorized position requirements are designated by a positional rank for each of a shift, a tour group, and a rotation.

4. The system for corrections facility staffing management of claim 3, further comprising:
an Overtime Tracking System configured to determine an operational gap in hours between an available staff and the minimum staffing requirement.

5. The system for corrections facility staffing management of claim 4, wherein the operational gap is determined each shift, tour, group, and rotation, during a specified temporal period.

6. The system for corrections facility staffing management of claim 5, wherein the Overtime Tracking System is configured to longitudinally map the operational gap in one or more predictive forecasts.

7. The system for corrections facility staffing management of claim 6, further comprising:
an Enhanced Overtime Code Mapping Tool configured to determine a full-time equivalent headcount required to fulfill the operational gap.

8. The system for corrections facility staffing management of claim 7, wherein the full-time equivalent headcount is determined by a positional rank, a salary hour of coverage provided by said full-time equivalent headcount.

9. The system for corrections facility staffing management of claim 7, wherein the Enhanced Overtime Code Mapping Tool is configured to determine a full coverage factor requirement as in-budget according to one or more overtime code categories and one or more sub-groups within said one or more overtime code categories.

10. The system for corrections facility staffing management of claim 7, wherein the Enhanced Overtime Code Mapping Tool is configured to determine a full coverage factor requirement as out-of-budget according to one or more emergency events outside of a budgeted headcount.

11. The system for corrections facility staffing management of claim 2, further comprising:
a Sequential Staff Sort System configured to assign a roster of assigned personnel to each of the one or more authorized position requirements of the validated architecturally structured authorized staff work schedule.

12. The system for corrections facility staffing management of claim 11, the roster of assigned personnel maintains operational continuity in one or more of a staff, a platoon, or a group.

13. The system for corrections facility staffing management of claim 11, the roster of assigned personnel accounts for scheduling of a contractual fringe benefit.
